(19) United States
(12) Patent Application Publication
(10) Pub. No.: US 2009/0169127 A1
(43) Pub. Date: Jul. 2, 2009

(54) Anti-vibration system for the display screen of an image display device

(76) Inventor: Tsung Yi Lu, Lujhu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,394

(22) Filed: Aug. 8, 2008

(30) Foreign Application Priority Data
Dec. 28, 2007 (TW) 96150999

(51) Int. Cl. G06K 9/40

(52) U.S. Cl. 382/255

(57) ABSTRACT

An anti-vibration system and a method thereof keep images to be displayed on a fixed location of a display screen while the display screen moves. The system includes: a three-dimensional phase detector for detecting the three-dimensional displacement of the display screen, an image control unit for recording the initial location of an image displayed on the display screen, a digital signal processor (DSP) for converting the three-dimensional displacement into a two-dimensional displacement and receiving the initial position of the image to calculate an initial location of another image, an image phase adjusting unit for adjusting the output range of the image and displaying the image on the screen according to the initial location of another image calculated by the DSP. The image is kept on the same location of the display screen, so that it will not vibrate due to the display screen moves.

### BACKGROUND OF THE INVENTION

1. Field of the Invention

The present invention relates to a system that prevents an image frame from vibrating as the image display device vibrates. In particular, the present invention relates to an anti-vibration system that detects the displacement of the image display device and calculates the output location of the image according to the displacement to maintain the image display location at a fixed location.

2. Description of the Related Art

There are a variety of digital devices that can display an image. Some of the digital devices are portable and can be carried by their user. When the user uses the portable digital device to watch the video files, pictures, or texts under a dynamic status, such as walking or sitting on a vehicle, the image display device will vibrate.

However, the image frame on the image display device does not change its display angle or location as the angle or the location of the image display device changes. Therefore, even though the user adjusts the image display device, the image parameters on the image display device are still not changed, such as the display frame and the image edge. If the image display range is not adjusted, the image frame may become slanted (referring to FIG. 1) or moved (referring to FIG. 2) when the user watches the image frame. If the user watches the texts or images on the display device in a continuously vibrating environment, the image frame also continuously vibrates. The user's eyes need to re-focus so that the user can clearly watch the image or texts. Therefore, the user's eyes will feel uncomfortable or the user will feel dizzy due to the image frame continuously vibrates.

Although there are a lot of technologies for preventing the image frame from vibrating, they usually control the vibration amplitude of the image frame. They cannot solve the problem of preventing the image frame from vibrating when the user continuously watches the image frame.

### SUMMARY OF THE INVENTION

In order to make the user comfortably watch the image frame on an image display device under a dynamic status, an anti-vibration system for preventing the image frame from vibrating is provided.

The anti-vibration system can be applied to a variety of display devices. The anti-vibration system has a display screen for outputting the image, text, or dynamic video and audio from the display device, a three-dimensional phase detector for continuously detecting the three-dimensional displacement of the display screen of the display device under a dynamic status, an image control unit for slightly lessening a first image on the display screen and recording the initial location of the first image, a digital signal processor, and an image phase adjusting unit. The digital signal processor receives the detected three-dimensional displacement, and converts the three-dimensional displacements into the two-dimensional displacements for matching the two-dimensional image frame on the display screen. According to the two-dimensional displacements and the initial location of the first image recorded by the image control unit, the location of a second image on the display screen is calculated to compensate the image displacement when the display device moves, and the initial location of the second image is outputted. The image phase adjusting unit receives the initial location of the second image, and cancels the image frame displacement caused by the displacement of the display screen and outputs the compensated image frame to the display screen.

The anti-vibration system can prevent the image frame from vibrating caused by the image display device operated under a dynamic status. When the image display device continuously moves, the three-dimensional phase detector also continuously detects the variation of the phase. The digital signal processor also continuously receives the phase variation and converts it into a two-dimensional displacement to adjust the output location of the image so that the image frame is kept at the same location on the viewing angle.

In order to prevent the image frame on the image display device from vibrating, the present invention also provides a method for preventing the image frame from vibrating. First, an image control unit records the initial location of a first image displayed on the display screen. When the display screen moves, a three-dimensional detector detects the three-dimensional displacement. The three-dimensional displacement is transmitted to a digital signal processor. The three-dimensional displacement is processed and converted into a two-dimensional displacement. The digital signal processor also receives the initial location of the first image.

According to the two-dimensional displacement and the initial location of the first image, the digital signal processor calculates an initial location of a second image that should be displayed on the moved display screen. By utilizing the two-dimensional displacement to change the location of the displayed image in an opposite direction, the displacement caused by the displacement of the display screen is cancelled. Next, a signal of the initial location of the second image is outputted. An image phase adjusting unit adjusts the output image frame and displays on the display screen according to the signal of the initial location of the second image.

By using the above method and the procedures, the output location of the image frame can be adjusted according to the displacement of the display screen to keep the image frame be fixed at the same location. The image frame does not vibrate due to the displacement of the display screen.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1A is a schematic diagram of the display screen be slanted of the prior art;

FIG. 1B is a schematic diagram of the display screen be moved of the prior art;

FIG. 2 is a schematic diagram of the anti-vibration for the display screen of the present invention;

FIG. 3A is a schematic diagram of the display screen and the image display range of the present invention;

FIG. 3B is a schematic diagram of the image displacement compensation of the present invention;

FIG. 3C is a schematic diagram of the image displacement that is not compensated of the present invention;

FIG. 4 is a schematic diagram of the direction of the displacement of the present invention;

FIG. 5A is a schematic diagram of the image frame without the anti-vibration effect;

FIG. 5B is a schematic diagram of the image frame with the anti-vibration effect of the present invention;

FIG. 5C is a schematic diagram of the output result of the anti-vibration system of the present invention;

FIG. 6 is a flow chart of the anti-vibration method for the image display device of the present invention; and

FIG. 7 is a flow chart of the anti-vibration method for the display screen of the present invention.

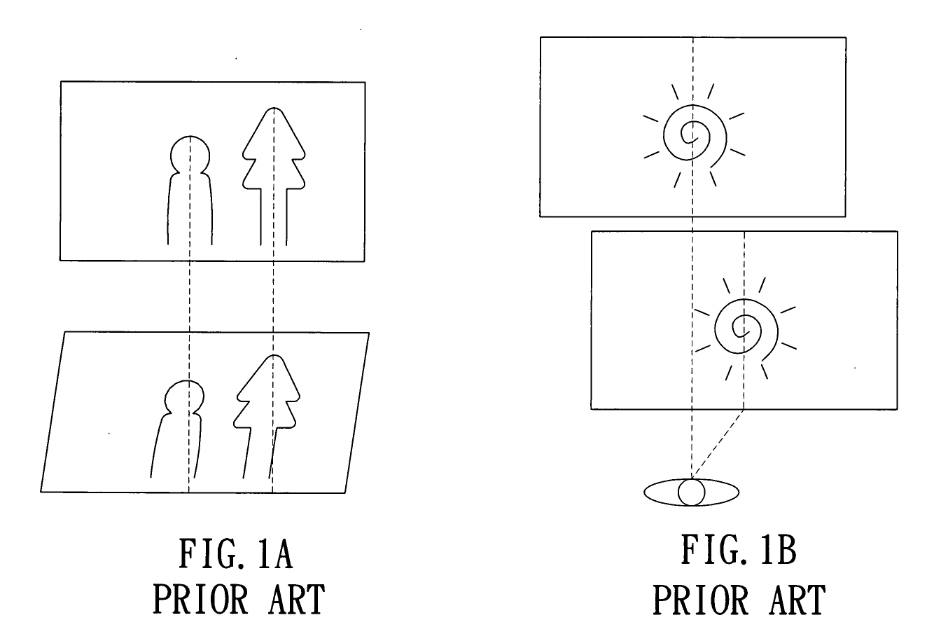

### DETAILED DESCRIPTION OF THE PREFERRED EMBODIMENTS

The present invention continuously detects the displacements of the image display screen, and uses the calculation units in the system to calculate the compensated displacements of the image frame caused by the displacements of the image display screen. The calculated result can provide a new image display range so that the output image frame is adjusted by the display device. Therefore, the image frame does not vibrate due to the display screen vibrates.

In order to make the concept and the technology be easily understood, the following and the pictures are used for illustrating the concept in detail.

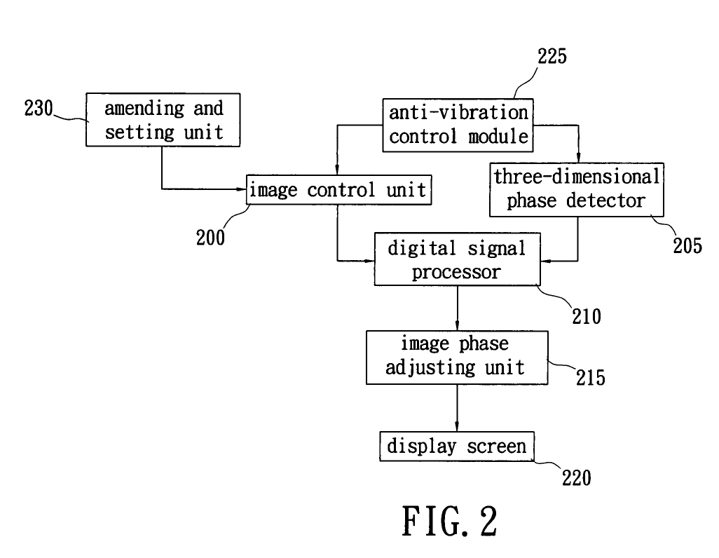

Reference is made to FIG. 2, which shows a diagram of the elements of the present invention that are suitable for the anti-vibration system for the image display device. The system has a display screen 220 for displaying the pictures, audio files, video files or texts on the display device. The system also has an image control unit 200 for recording the initial location (named as a first image initial location) of the picture, the frame of the text, or the image frame of the video file displayed on the display screen 220. The initial location means that the location of the first pixel of the image appeared on the display screen 220 when the image frame is outputted onto the display screen 220.

The system also has a three-dimensional phase detector 205 for detecting the displacement of the display screen 220 in a three-dimensional space. When the display screen 220 vibrates, the display screen 220 may have a horizontal displacement and a vertical displacement, and its slanted angle also changes. Therefore, the anti-vibrate system needs to detect the displacement and the displacement direction to adjust the image location to cancel the displacement according to the displacement and the displacement direction of the display screen 220.

The three-dimensional phase detector 205 continuously detects the three-dimensional displacement of the display screen 220, and transmits the detected displacement to the digital signal processor 210. After the digital signal processor 210 receives the three-dimensional displacement, the three-dimensional displacement is converted into a two-dimensional displacement for achieving the goal of displaying the image on a two-dimensional screen. The digital signal processor 210 also obtains the first image initial location recorded by the image control unit 200, and adjusts the first image initial location according to the calculated two-dimensional displacement. Therefore, the original image that has changed its location due to the vibration of the display screen 220 is adjusted for matching the displacement. The adjusted image frame displayed on the display screen 220 is called as a second image. When the adjusted second image is displayed on the display screen 220, the image frame is linked to the first image so that the image frame is kept on the same location in the viewing direction. The display effect is the same as the display effect that the display screen 220 does not vibrate.

After the digital signal processor 210 calculates the location of the image for canceling the displacement caused by the vibration of the display screen 220, the initial location signal of the second image is generated and is transmitted to the image phase adjusting unit 215. The image phase adjusting unit 215 adjusts the image location of the image display range of the image frame that is outputted to the display screen 220 according to the initial location signal of the second image. Finally, the image frame is displayed on the display screen 220, and the image frame does not vibrate even though the display device vibrates.

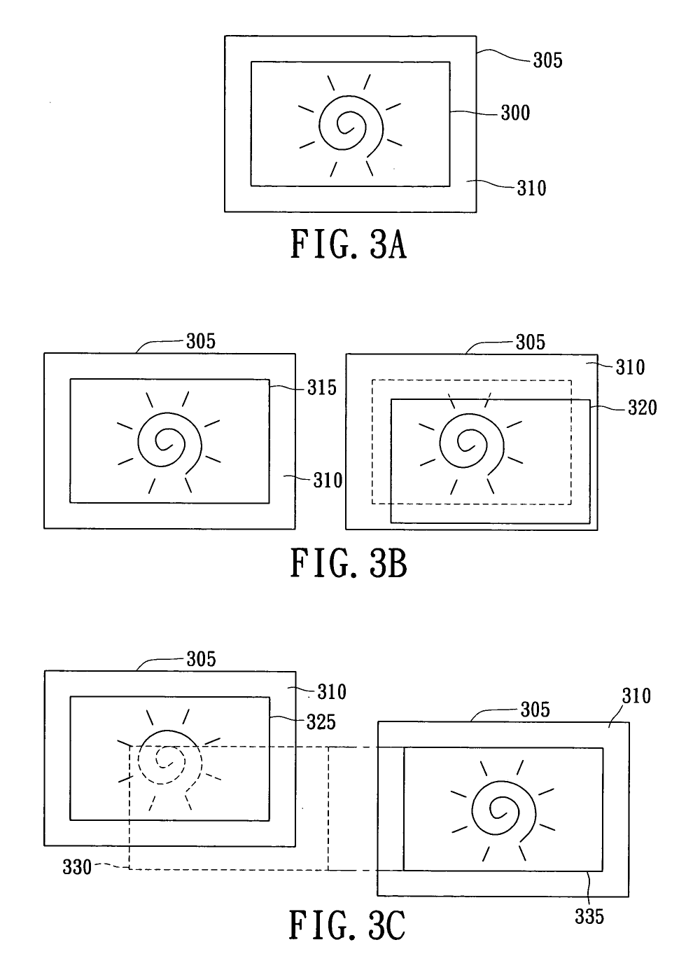

In this embodiment, the system also has an amending and setting unit 230 for setting the margin area of the display screen 220. The margin area is used for adjusting the output location of the second image by the system. Referring to FIG. 3A, the space between the image 300, such as text, picture, or video file, and the display edge 305 of the display screen 220 is the margin area 310 for adjusting the output location of the second image.

When the image phase adjusting unit 215 adjusts the image location and the image edge according to the initial location signal of the second image, the image phase adjusting unit 215 also checks whether the adjusted image location is exceeding the compensation range of the present system or not. Reference is made to FIG. 3B, and the illustration is below. After the image phase adjusting unit 215 receives the initial location signal of the second image, the image phase adjusting unit 215 checks the display location and the range of the moved second image 320 displayed on the display screen 220. When the second image 320 is within the adjustable range of the margin area 310, the image phase adjusting unit 215 outputs the image frame of the second image 320 according to the initial location of the second image and the edge of the second image. In the opposite aspect, referring to FIG. 3C, When the image edge of the moved second image 330 is exceeding the adjustable range of the margin area 310, the image phase adjusting unit 215 does not use the calculated image edge of the second image 330 to move the first image 335 as the displacement of the display screen 220. The image phase adjusting unit 215 uses the image frame of the first image 325 before moved as the image frame of the image 325.

In this system, the characteristics of the digital signal processor (DSP) include: its execution speed is high, the total performance is excellent, and it can be operated in a real-time mode. The DSP is suitable for the continuous and real-time image output calculation.

In this embodiment, the system also has an anti-vibration control module 225 for controlling the anti-vibration system to be turned on or turned off. The anti-vibration control module 225 indicates the image control unit 200 to record the initial location of the first image and transmit the initial location of the first image to the DSP 210. Furthermore, the three-dimensional phase detector 205 also refers to the instruction of the anti-vibration control module 225 to transmit the three-dimensional displacement to the DSP 210. When the anti-vibration control module 225 does not issue the instruction of turning on the anti-vibration function, or issues the instruction of turning off the anti-vibration function, the three-dimensional phase detector 205 continuously detects the phase change, and does not transmit the phase change to the DSP 210. Thereby, the anti-vibration function of the system is turned off.

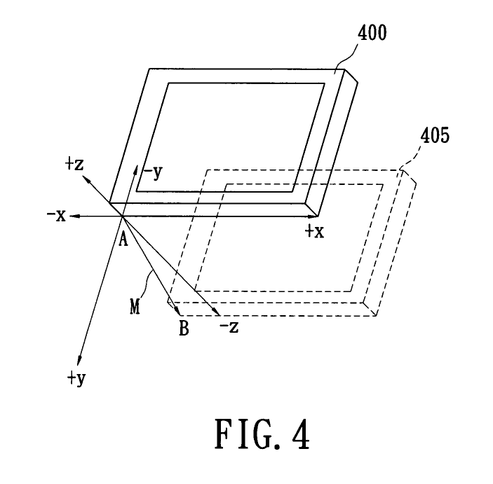

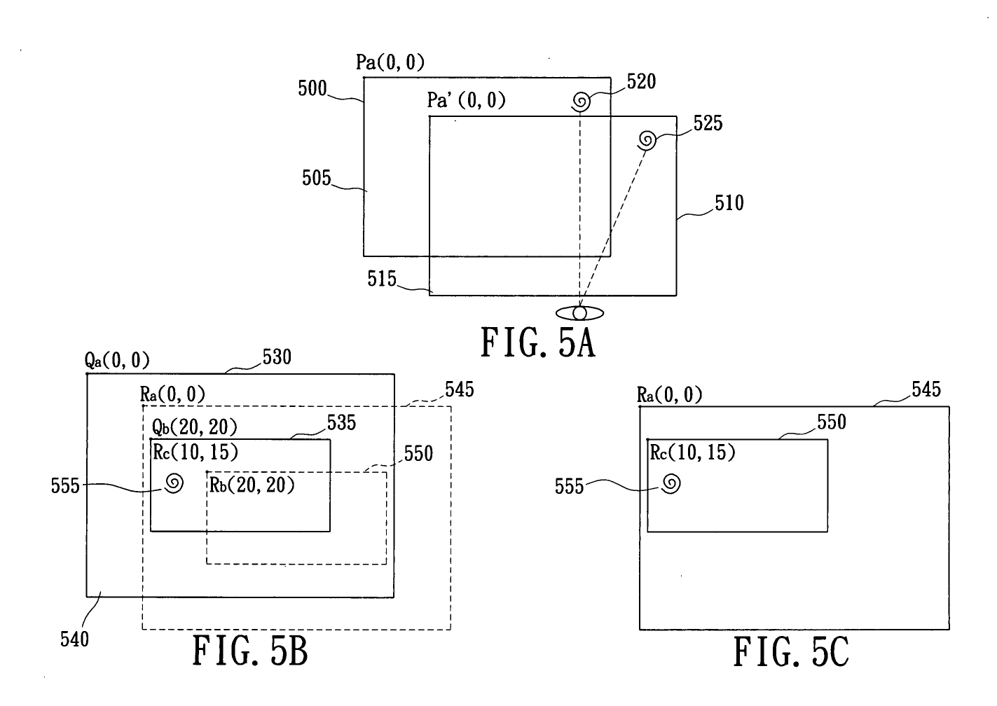

In order to illustrate the difference of the image frames that has been processed by the anti-vibration system and has not been processed by the anti-vibration system, the following and the pictures are used as an example. Reference is made to FIG. 4. In this embodiment, for the three dimension displacements detected by the three-dimensional phase detector 205, the plane composed of two dimensions is parallel to the display screen 400 that is not moved yet (the xy plane), and the third dimension is vertical to the display screen 400 (the z plane). Therefore, when the display screen 400 is moved upwards or downwards, or is slanted, the displacement in vertical direction does not affect the image display. When the display screen 400 is moved right-downwards to the location of the display screen 405, a displacement M from point A to point B is generated. The displacement M is decomposed into three-dimensional displacements +x′, +y′, −z′. Because the z coordinate is vertical to the display screen, merely the +x′ and +y′ displacements needs to be cancelled when the display location of the image is adjusted. Therefore, a plane displacement in FIG. 5 directly uses as an example. This means that the z-coordinate displacement of the image display device is not illustrated.

FIG. 5A shows a schematic diagram of the image frame without the anti-vibration function. The resolution of the display screen 500 is 3096×2328. There is a picture 505 on the display screen 500. The display locations of the picture 505 are from point zero Pₐ (0,0) to point (3095,2327). This means that the image edge of the picture 505 is the same as the display edge of the display screen 500. When the display screen 500 is moved right-downwards to the location of the display screen 510, the picture 505 is also moved right-downwards to the location of the picture 515 due to the anti-vibration function is not turned on. At this moment, the start point of the image edge of the picture 515 is still the point zero P′ₐ (0,0). The location of the object 520 on the picture 505 is moved to the location of the object 525 due to the display screen is moved. The user that can directly view the object needs to move the line of vision to the location of the object 525.

FIG. 5B shows a schematic diagram of the image frame that its output location of the image is adjusted and the displacement is compensated.

In this embodiment, when the image control unit 200 receives the instruction of turning on the anti-vibration function from the anti-vibration control module 225, the image control unit 200 reduces the picture 535 that its original size is the same as the display edge, so that the display area is smaller than the display edge of the display screen 530, merely 3056×2888 pixels. The display start point of the picture 535 becomes point Q_{b}(20,20) from Qₐ(0,0). Between picture 535 and the display screen 530, there is a space with 20 pixels for each side. This means that the picture 535 has a ±20 pixels displacement space in the x coordinate and the y coordinate. The space is the margin area 540 for adjusting the output location of the picture 535 when the display screen 530 is moved (in order to illustrate the relation between the image and the margin area, the image and the margin area is not shown in a correct ratio). The size of the margin area is controlled by the amending and setting unit. The size of the margin area can be ±20 pixels in the x coordinate and the y coordinate, ±40 pixels in the x coordinate and the y coordinate, or ±80 pixels in the x coordinate and the y coordinate, that depends on the requirement. The larger is the size of the margin area, the larger is the adjustable image edge for the output location of the image. The compensation effect is better. However, the display size of the picture 535 is reduced and its resolution is also affected.

When the picture 535 on the display screen 530 is reduced and the display screen 530 is moved 10 units along +x direction, 5 units along +y direction and 10 units along +z direction to be the display screen 545, the three-dimensional phase detector in the system transmits the detected three-dimensional displacement (+10, +5, +10) to the DSP 210. The three-dimensional displacement (+10, +5, +10) is converted into the two-dimensional displacement (+10, +5). The plane displacement (+10, +5) is obtained. The DSP 210 calculates the compensation displacement to cancel the plane displacement. The display location of the picture 550 on the display screen 545 needs to be moved 10 units along the −x direction, and 5 units along −y direction. The start point for the picture 550 on the display screen 545 is changed to R_{c}(10, 15) from Rᵢ(20, 20).

The DSP 210 transmits the initial location (10, 15) for compensating the output picture to the image phase adjusting unit 215 via a signal. The image phase adjusting unit 215 uses the signal as the initial location of the displayed picture to arrange the image edge. In this example, (10, 15), (10, 2302), (3065, 2302), and (3065, 15) forms the image edge. Because the compensation displacement is calculated by the DSP 210 to cancel the x and y displacements, the calculation result makes the location of R_{c} be equal to the location of Q_{b}. The location of the displayed picture on the display screen 545 is shown in FIG. 5C. The display location of the picture is overlapped with the location of the picture 535 that has not been moved. Therefore, the object 555 on the picture is kept on the same location of the user's line of vision. The problem of the object 520 and object 525 in FIG. 5A being vibrated is avoided.

The compensated image displacement of the anti-vibration system is limited by the size of the margin area. In FIG. 5B, the setting value between the picture 535 and the display screen range set by the amending and setting unit is ±20 pixels in the x coordinate and the y coordinate. Therefore, for the initial location Q_{b}(20, 20) of the picture 535, its movable range is a square formed by point (0, 0) and the point (40, 40). This means that the displacement for the picture 535 does not exceed ±20 pixels in the x coordinate and the y coordinate. In other words, the initial location R_{c} of the adjusted output range will be any point located in the area surrounded by (0, 0) and (40, 40) of the display screen 530.When the displacement of the display screen 545 exceeds the limitation of the margin area 540, the system does not adjust the image location. The system moves the picture 550 according to the displacement of the display screen 545, and its initial location is R_{b}, not R_{c}, such as shown in FIG. 5A.

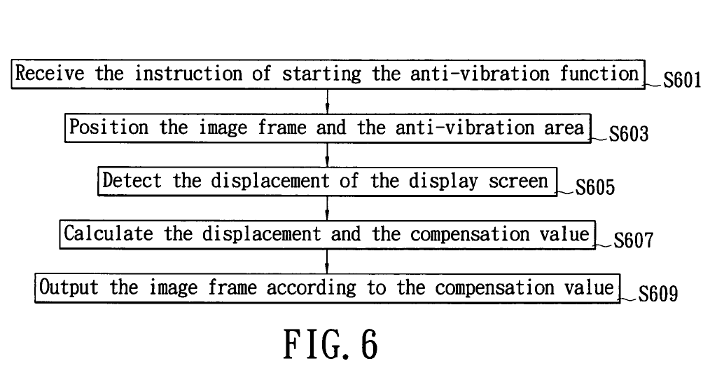

The present invention also provides a method for preventing the display image frame from vibrating. The steps of the method for preventing the display image frame from vibrating are shown in FIG. 6.

The anti-vibration function is triggered by an anti-vibration starting instruction (S601). When the anti-vibration function is turned on, the image location and the anti-vibration area of the display screen 220 are positioned (S603). Next, a three-dimensional phase detector 205 detects the moving direction and displacement of the display screen 205 (S605), and transmits the detected moving direction and displacement to the DSP 210. The DSP 210 calculates the moving direction and displacement to obtain the compensation value and direction of the image frame to cancel the displacement of the display screen 205 (S607). According to the calculated compensation value and direction, the image frame is outputted to the exact location on the display screen 220 (S609).

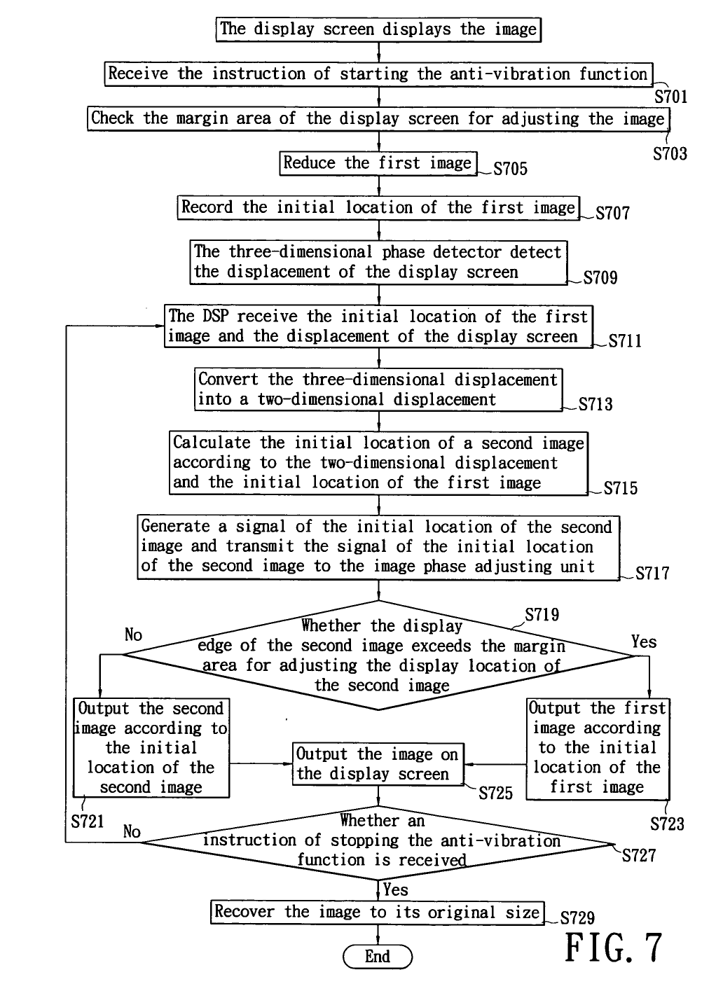

In order to illustrate the present invention in detail, an example is used for illustrating the content of the present invention. Reference is made to FIG. 7.

When the display screen 220 displays image, an instruction for starting the anti-vibration function is received (S701). The anti-vibration control module 225 checks the size of the margin area set by the amending and setting unit 230 (S703). According to the size of the margin area, the first image displayed on the display screen 220 is reduced (S705). The image control unit 200 records the initial location of the first pixel of the reduced image displayed on the display screen 220 (S707). At this moment, the display screen 220 is moved, the three-dimensional phase detector 205 detects the displacement of the display screen 220 in the three-dimension space (S709). After the three-dimensional phase detector 205 obtains the displacement, the displacement is transmitted to the DSP 210. At this time, the image control unit 200 also transmits the recorded initial location of the first image to the DSP 210 (S711).

The DSP 210 converts the three-dimensional displacement into a two-dimensional displacement (S713). According to the two-dimensional displacement, the adjusted direction and displacement for the initial location of the first image is calculated so that the image display range composed of the initial location of the second image can cancel the image displacement caused by the movement of the displacement screen (S715).

The DSP 210 generates a signal of the initial location of the second image and outputs the initial location of the second image to the image phase adjusting unit 215 (S717). According to the received signal, the image phase adjusting unit 215 checks whether the image range calculated by the DSP exceeds the margin area for adjusting the image or not (S719). When the display location of the image does not exceed the adjustable range of the margin area (this means that the image edge of the image does not exceed the range of the display screen 220), the image phase adjusting unit 215 uses the range composed of the initial location indicated by the signal as the image edge of the image to compensate the image displacement (S721). When the display location of the image exceeds the adjustable range of the margin area, the image phase adjusting unit 215 does not use the range composed of the initial location indicated by the signal to adjust the image edge, and the image location that is moved as the display screen and is not compensated is outputted (S723). Next, the checked image frame is outputted to the display screen 220 (S725).

After the adjusted image is outputted, the user determines whether the anti-vibration function is turned off or not. Therefore, whether an instruction of stopping the anti-vibration function is received is determined (S727). If the anti-vibration function is not turned off and the display screen 220 is moved, the three-dimensional phase detector 205 continuously transmits the detected three-dimensional displacement to the DSP 210, and the steps (from S711) are repeated. If the anti-vibration function is turned off, the system does not adjust the image location, and recovers the image size (S729), and the procedure is ended.

The present invention can be applied to the devices with a display screen for navigating, watching, or reading, such as digital still cameras, video cameras, PDAs or e-books, etc. The image, such as picture, video, and text, displayed on the display screen is adjusted and displayed.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. An anti-vibration system for the display screen of an image display device, comprising:
a display screen for outputting an image of a static picture or a dynamic video by the image display device;
an image control unit for reducing a first image displayed on the display screen, and recording and transmitting the initial location of the first image displayed on the display screen;
a three-dimensional phase detector for continuously detecting the three-dimensional displacement of the display screen;
a digital signal processor for receiving the initial location of the first image and the three-dimensional displacement, wherein the three-dimensional displacement is calculated and converted into a two-dimensional displacement, an initial location of a second image after the image display screen is moved is calculated according to the initial location of the first image and the two-dimensional displacement, and the digital signal processor outputs a signal containing the initial location of the second image according to the initial location of the second image; and
an image phase adjusting unit for receiving the initial location of the second image, wherein the image phase adjusting unit adjusts the location of the image edge according to the signal of the initial location of the second image and outputs the image frame to the display screen.

2. The anti-vibration system for the display screen of an image display device as claimed in claim 1, further comprising an anti-vibration control module that controls the three-dimensional phase detector to start or stop transmitting the three-dimensional phase displacement to the digital signal processor in order to turn on or turn off the anti-vibration system.

3. The anti-vibration system for the display screen of an image display device as claimed in claim 2, wherein the three-dimensional phase detector sets the location of the display screen on the anti-vibration control module turning on the anti-vibration function as the initial location for vibration detecting.

4. The anti-vibration system for the display screen of an image display device as claimed in claim 1, further comprising an amending and setting unit for setting the margin area of the display screen, and the display margin area is used for adjusting the display location of the second image by the system.

5. The anti-vibration system for the display screen of an image display device as claimed in claim 4, wherein the area of the display screen exceeding the reduced first image is the display margin area set by the amending and setting unit.

6. The anti-vibration system for the display screen of an image display device as claimed in claim 1, wherein the plane formed by two dimensions of the three dimensions detected by the three-dimensional phase detector is parallel to the display screen, and the third dimension is vertical to the display screen.

7. The anti-vibration system for the display screen of an image display device as claimed in claim 1, wherein when the image is a dynamic video file, and the initial location of the first image recorded by the image control unit is the initial location of a single image frame of the dynamic video file.

8. An anti-vibration method for the display screen of an image display device, comprising:
receiving an instruction of starting the image anti-vibration function;
recording the location of the display screen;
detecting the three-dimensional displacement of the display screen;
converting the three-dimensional displacement into a two-dimensional displacement and calculating the compensating value for the image frame; and
outputting the image frame to the display screen according to the compensating value.

9. The anti-vibration method for the display screen of an image display device as claimed in claim 8, wherein the step of recording a location of the display screen comprises:
reading a margin area of the display screen set by an amending and setting unit, wherein the margin area is used for adjusting the display location of a second image;
reducing a first image displayed on the display screen to make the image frame of the first image smaller than the display edge of the display screen according to the range of the margin area; and
recording the initial location of the first image by an image control unit.

10. The anti-vibration method for the display screen of an image display device as claimed in claim 9, wherein the step of converting the three-dimensional displacement into a two-dimensional displacement and calculating the compensating value for the image frame comprises:
receiving the three-dimensional displacement and converting the three-dimensional displacement into the two-dimensional displacement by a digital signal processor; and
calculating an initial location of a second image displayed on the moved display screen according to the two-dimensional displacement and the initial location of the first image so that the image displacement caused by the movement of the display screen is compensated when the display screen outputs the second image.

11. The anti-vibration method for the display screen of an image display device as claimed in claim 10, wherein the step of outputting the image frame according to the compensation value further comprises:
determining whether an instruction of stopping the image anti-vibration function is received or not; and
stopping transmitting the three-dimensional displacement to the digital signal processor when the instruction of stopping the image anti-vibration function is received.

12. The anti-vibration method for the display screen of an image display device as claimed in claim 10, wherein the step of calculating the initial location of the second image further comprises:
outputting a signal of the initial location of the second image according to the initial location of the second image; and
adjusting the location of the image edge of the image displayed on the display screen according to the signal of the initial location of the second image.

13. The anti-vibration method for the display screen of an image display device as claimed in claim 12, wherein the step of adjusting the location of the image edge of the image displayed on the display screen according to the signal of the initial location of the second image comprises:
detecting whether the second image composed of the initial location of the second image exceeds the display edge of the display screen or not by an image phase adjusting unit;
the image phase adjusting unit using the second image composed of the initial location of the second image to replace the first image and outputting the second image to the display screen, if the second image does not exceed the display edge of the display screen; and
the image phase adjusting unit ignoring the second image composed of the initial location of the second image and outputting the first image to the display screen, if the second image exceeds the display edge of the display screen.
